(19) United States
(12) Patent Application Publication
(10) Pub. No.: US 2026/0254155 A1
(43) Pub. Date: Aug. 27, 2026

(54) WATERPROOF COVER AND CONNECTOR ASSEMBLY

(71) Applicant: BIZLINK INTERNATIONAL CORP., New Taipei City (TW)

(72) Inventors: Yanping ZHANG, New Taipei City (TW); Qixing XU, New Taipei City (TW); Haoran ZOU, New Taipei City (TW)

(21) Appl. No.: 19/064,625

(22) Filed: Feb. 26, 2025

(51) Int. Cl. H01R 13/52; H01R 13/502

(52) U.S. Cl. CPC H01R 13/5213; H01R 13/5025; H01R 13/5202

(57) ABSTRACT

A waterproof cover includes an upper cover and a lower cover. The upper cover includes an upper cover main body and a plurality of elastic arms extending from the upper cover main body. The elastic arms surround and jointly define an aperture. The upper cover has a first slot and a second slot between the upper cover main body and each of the elastic arms, such that the elastic arms deform in a radial direction. The lower cover is coupled to the upper cover. The lower cover includes a lower cover main body and a connecting portion interconnected with each other. The connecting portion passes through the aperture and is clamped by the elastic arms.

### BACKGROUND

### Field of Invention

The present invention relates to a waterproof cover and a connector assembly.

### Description of Related Art

In some cases, a server will be installed in an outdoor environment, so water vapor can easily enter the server through a socket of a connector assembly, causing internal components to become damp or corroded, thereby affecting the operation of the server. The existing method to solve the above problem is to provide a waterproof cover at a side of the socket. As the socket is not connected to a plug, the waterproof cover covers an opening of the socket to seal the socket. The waterproof cover includes an upper cover and a lower cover. The upper cover has a hole, and the lower cover is inserted into the hole. The lower cover and the hole are assembled by hard interference. The hole is prone to breakage during the assembly, causing sealing failure.

How to propose a waterproof cover and a connector assembly that can solve the aforementioned problems is one of the problems that the industry is currently eager to invest in research and development resources to solve.

### SUMMARY

In view of this, one purpose of the present disclosure is to provide a waterproof cover and a connector assembly that can solve the aforementioned problems.

In order to achieve the above objective, according to an embodiment of the present disclosure, a waterproof cover includes an upper cover and a lower cover. The upper cover includes an upper cover main body and a plurality of elastic arms extending from the upper cover main body. The elastic arms surround and jointly define an aperture. The upper cover has a first slot and a second slot between the upper cover main body and each of the elastic arms, such that the elastic arms deform in a radial direction. The lower cover is coupled to the upper cover. The lower cover includes a lower cover main body and a connecting portion interconnected with each other. The connecting portion passes through the aperture and is clamped by the elastic arms.

### BRIEF DESCRIPTION OF THE DRAWINGS

The invention can be more fully understood by reading the following detailed description of the embodiment, with reference made to the accompanying drawings as follows:

FIG. 1 is a perspective view of a connector assembly in accordance with an embodiment of the present disclosure;

FIG. 2 is a perspective view of a housing and a socket in accordance with an embodiment of the present disclosure;

FIG. 3 is a top view of the connector assembly in accordance with an embodiment of the present disclosure;

FIG. 4 is a perspective view of a waterproof cover in accordance with an embodiment of the present disclosure;

FIG. 5 is a top view of an upper cover in accordance with an embodiment of the present disclosure;

FIG. 6 is a perspective view of a lower cover in accordance with an embodiment of the present disclosure; and

FIG. 7 is a cross-sectional view of the connector assembly based on a section A-A′ of FIG. 3 in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in a connector assembly 100 of this embodiment and the connection relationship between the components will be described in detail.

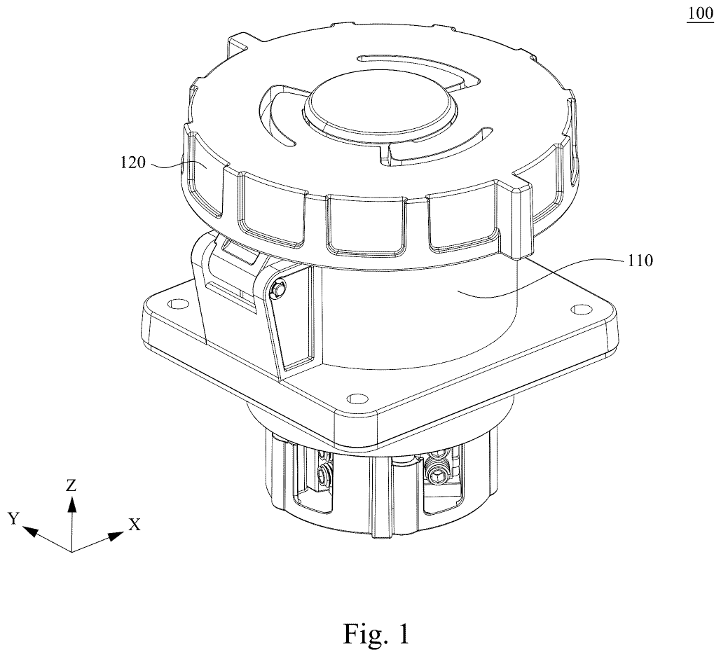

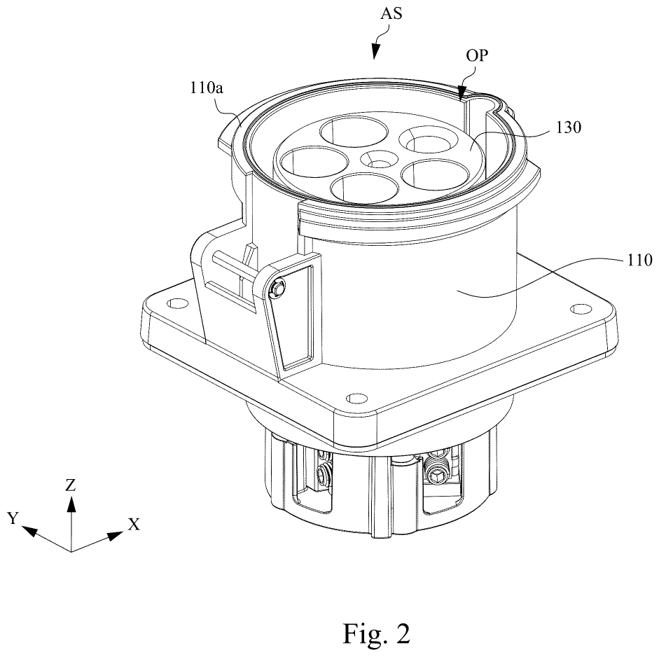

Reference is made to FIG. 1. FIG. 1 is a perspective view of a connector assembly 100 in accordance with an embodiment of the present disclosure. As shown in FIG. 1, in this embodiment, the connector assembly 100 is configured to accommodate a socket (shown in FIG. 2). The connector assembly 100 includes a housing 110 and a waterproof cover 120. The waterproof cover 120 covers the housing 110. Specifically, the waterproof cover 120 seals the housing 110, and the waterproof cover 120 is detachably disposed on the housing 110. In some embodiments, the waterproof cover 120 is pivotally connected to the housing 110 by a rotating shaft extending along an axis parallel to y-direction.

In some embodiments, the connector assembly 100 is configured as a female connector. The connector assembly 100 is further configured to be coupled to a plug configured as a male connector (not depicted).

In some embodiments, the housing 110 further includes a wing portion surrounding a side surface of the housing 110. The wing portion has a tabular shape. Specifically, the wing portion extends along x-y plane.

Reference is made to FIG. 2. FIG. 2 is a perspective view of the housing 110 and a socket 130 in accordance with an embodiment of the present disclosure. For simplicity, the waterproof cover 120 is omitted in FIG. 2. As shown in FIG. 2, in this embodiment, the connector assembly 100 further includes a socket 130. The socket 130 is located in the housing 110. Specifically, the housing 110 is tube-shaped and has an accommodating space AS and an opening OP. The accommodating space AS is defined by the housing 110 with an enclosed shape. The opening OP is located at an end of the housing 110. The socket 130 is located in the accommodating space AS of the housing 110. The waterproof cover 120 seals the opening OP of housing 110. The housing 110 further has a front end surface 110a. The front end surface 110a extends along an edge of the opening OP. The edge of the opening OP is ring-shaped. The front end surface 110a circumferentially extends along the edge of the opening OP. In some embodiments, a top surface of the socket 130 is lower than the front end surface 110a of the housing 110.

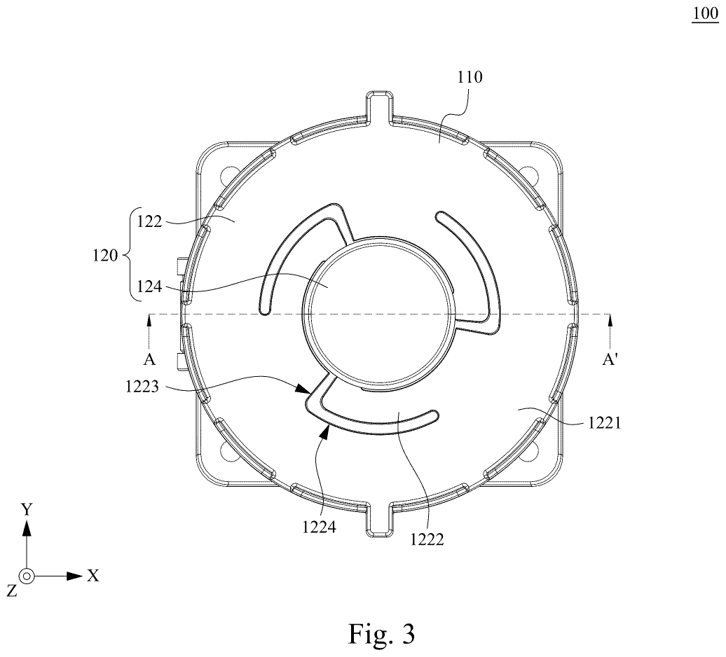

Reference is made to FIG. 3. FIG. 3 is a top view of the connector assembly 100 in accordance with an embodiment of the present disclosure. As shown in FIG. 3, in this embodiment, the waterproof cover 120 is located over the housing 110. The waterproof cover 120 includes an upper cover 122 and a lower cover 124. The lower cover 124 is coupled to the upper cover 122. The upper cover 122 includes an upper cover main body 1221 and a plurality of elastic arms 1222. The upper cover main body 1221 is disk-shaped. The elastic arms 1222 extend from the upper cover main body 1221. Specifically, the elastic arms 1222 circumferentially extend from the upper cover main body 1221. The elastic arms 1222 clamp a portion of the lower cover 124. The upper cover 122 further has a first slot 1223 and a second slot 1224. The first slot 1223 and the second slot 1224 are located between the upper cover main body 1221 and each of the elastic arms 1222, such that the elastic arms 1222 deform in a radial direction. The first slot 1223 and the second slot 1224 penetrate through the upper cover main body 1221. An end of the first slot 1223 is connected to an end of the second slot 1224, such that the first slot 1223 communicates with the second slot 1224. The first slot 1223 and the second slot 1224 extend in different directions.

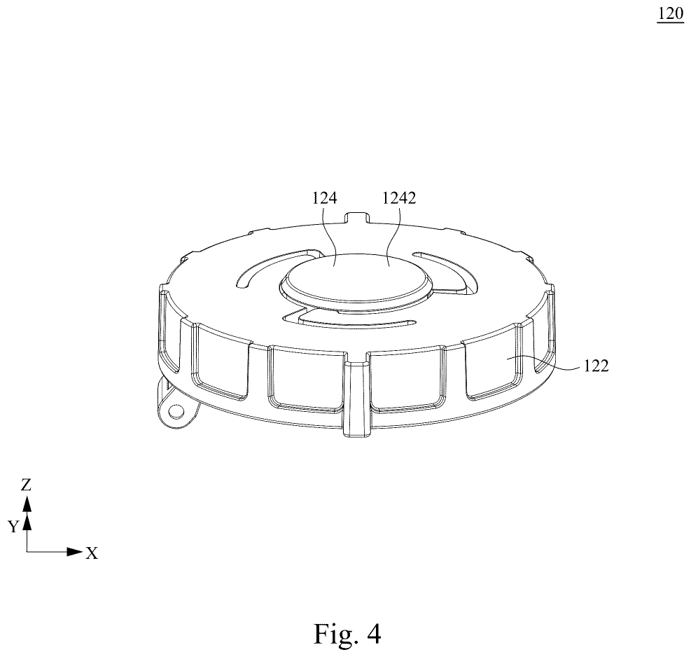

Reference is made to FIG. 4. FIG. 4 is a perspective view of the waterproof cover 120 in accordance with an embodiment of the present disclosure. As shown in FIG. 4, in this embodiment, the lower cover 124 is engaged with the upper cover 122. Specifically, the lower cover 124 includes a connecting portion 1242. As shown in FIG. 3 and FIG. 4, the elastic arms 1222 of the upper cover 122 clamp the connecting portion 1242 of the lower cover 124. The connecting portion 1242 passes through the upper cover 122 and is raised above the upper cover 122.

As shown in FIG. 4, in some embodiments, the connecting portion 1242 of the lower cover 124 is generally circular-shaped. In some embodiments, the connecting portion 1242 is located at a center of the upper cover 122.

In this embodiment, the upper cover 122 and the lower cover 124 can be made of hard plastic materials, such as ABS plastic or PC plastic. The hard plastic materials have greater strength, higher hardness, and good weather resistance. In the long term, as the waterproof cover 120 is exposed under the natural environment for a long time, such as sunlight, rain, temperature changes, etc., the waterproof cover 120 can still maintain good performance thereof and is less likely to age, fade, or deform.

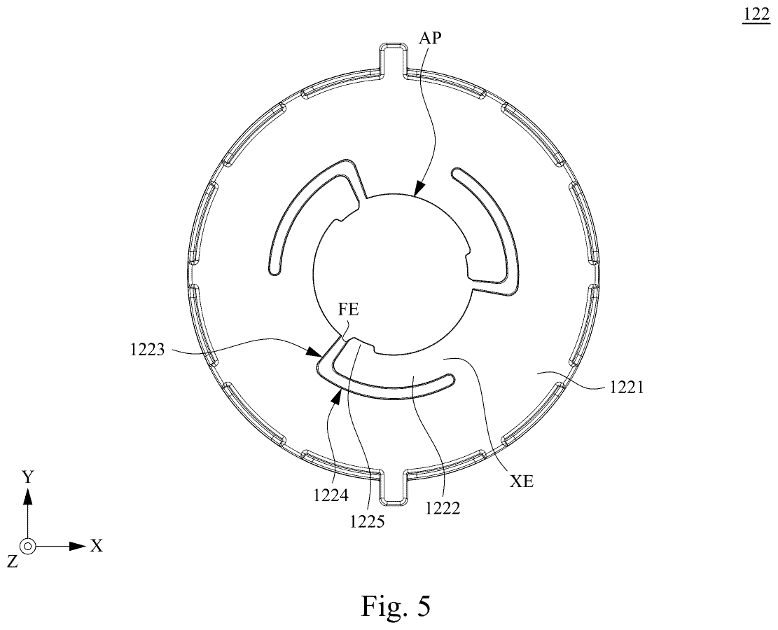

Reference is made to FIG. 5. FIG. 5 is a top view of the upper cover 122 in accordance with an embodiment of the present disclosure. As shown in FIG. 5, in this embodiment, the upper cover 122 further includes a finger portion 1225. The finger portion 1225 is located at an end of each of the elastic arms 1222. Specifically, each of the elastic arms 1222 has a fixed end XE and a free end FE. The fixed end XE contacts the upper cover main body 1221. The free end FE is separated from the upper cover main body 1221 by the first slot 1223 and the second slot 1224. The finger portion 1225 is located at the free end FE of each of the elastic arms 1222. More specifically, the finger portion 1225 is disposed on a side of each of the elastic arms 1222 away from the upper cover main body 1221. The finger portion 1225 is configured to abut against the connecting portion 1242. As shown in FIG. 5, the elastic arms 1222 surround and jointly define an aperture AP. In some embodiments, the aperture AP is located at a center of the upper cover main body 1221. As shown in FIG. 3 to FIG. 5, the connecting portion 1242 passes through the aperture AP of the upper cover 122. The connecting portion 1242 of the lower cover 124 is clamped by the elastic arms 1222 of the upper cover 122.

Reference is made again to FIG. 5. As shown in FIG. 5, the first slot 1223 is radially extended. In some embodiments, the first slot 1223 is linear-shaped. The second slot 1224 is circumferentially extended. In some embodiments, the second slot 1224 is arc-shaped. The first slot 1223 and the second slot 1224 conform to an edge of the elastic arms 1222. In other words, the first slot 1223 and the second slot 1224 jointly define at least one part of a contour of each of the elastic arms 1222.

Reference is made again to FIG. 5. In some embodiments, the elastic arms 1222 include at least two elastic arms 1222. For instance, the upper cover 122 may include two elastic arms 1222, three elastic arms 1222, or more than three elastic arms 1222. The elastic arms 1222 are disposed spaced apart from each other along a circumferential direction. The elastic arms 1222 jointly abut against a side surface of the connecting portion 1242. In some embodiments in which the upper cover 122 includes three elastic arms 1222, lengths of the three elastic arms 1222 are identical.

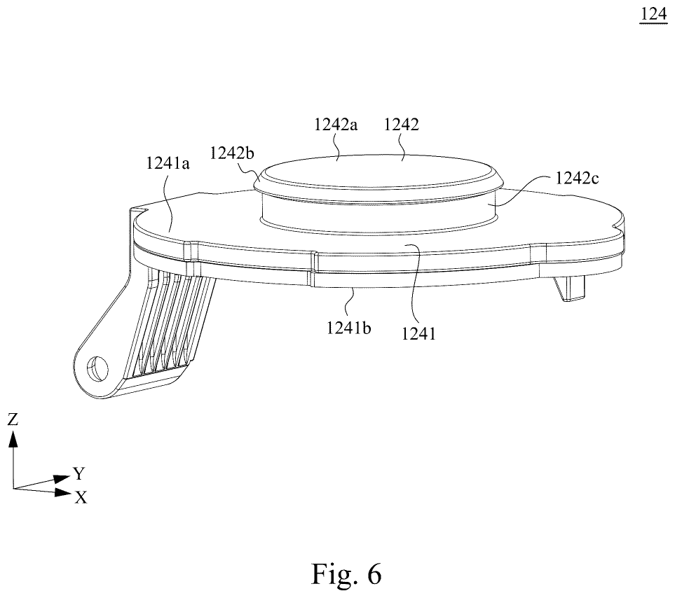

Reference is made to FIG. 6. FIG. 6 is a perspective view of the lower cover 124 in accordance with an embodiment of the present disclosure. As shown in FIG. 6, in this embodiment, the lower cover 124 further includes a lower cover main body 1241. The lower cover main body 1241 is disk-shaped. The connecting portion 1242 is generally column-shaped. The connecting portion 1242 is disposed on the lower cover main body 1241. The connecting portion 1242 and the lower cover main body 1241 are interconnected with each other. In some embodiments, the connecting portion 1242 is located at a center of the lower cover main body 1241. In some embodiments, in a top view along z-direction, the connecting portion 1242 and the lower cover main body 1241 are concentrically disposed. The connecting portion 1242 has a top surface 1242a, a guiding inclined surface 1242b, and a side surface 1242c. The side surface 1242c of the connecting portion 1242 directly contacts a top surface 1241a of the lower cover main body 1241. The top surface 1242a is located over the side surface 1242c. The guiding inclined surface 1242b is connected to the top surface 1242a. Specifically, the guiding inclined surface 1242b directly contacts the top surface 1242a. The guiding inclined surface 1242b is located between the side surface 1242c and the top surface 1242a.

Reference is made again to FIG. 6. As shown in FIG. 6, the guiding inclined surface 1242b extends along a circumferential direction of the connecting portion 1242. More specifically, the guiding inclined surface 1242b is inclined away from a central axis of the connecting portion 1242 along a direction, in which the aforementioned direction is from the top surface 1242a of the connecting portion 1242 to the top surface 1241a of the lower cover main body 1241, such that the connecting portion is generally mushroom-shaped.

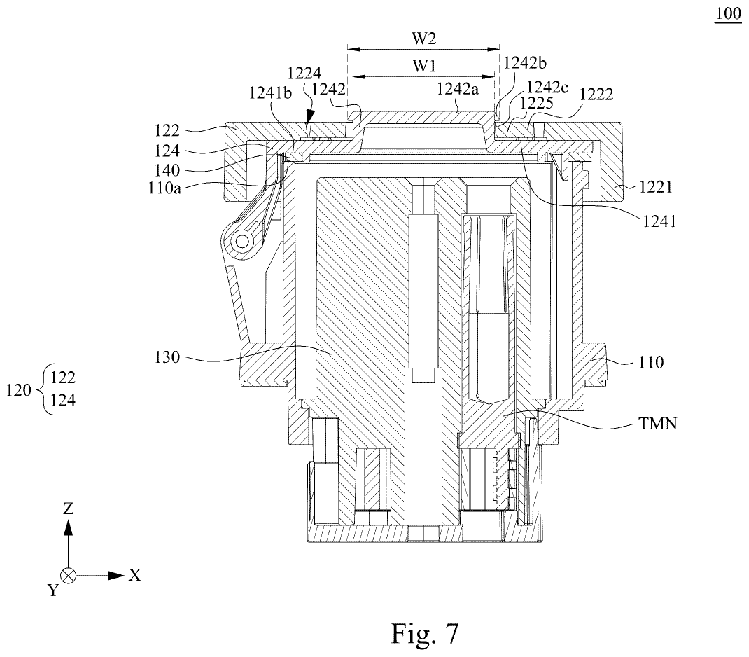

Reference is made to FIG. 7. FIG. 7 is a cross-sectional view of the connector assembly 100 based on the section A-A′ of FIG. 3 in accordance with an embodiment of the present disclosure. As shown in FIG. 7, in this embodiment, the connector assembly 100 further includes a sealing part 140. The sealing part 140 is located between the waterproof cover 120 and the housing 110. Specifically, the sealing part 140 is clamped between the lower cover 124 and the opening OP of the housing 110. The lower cover main body 1241 covers the edge of the opening OP. For instance, the sealing part 140 is located between a bottom surface 1241b of the lower cover main body 1241 and the front end surface 110a of the opening OP of the housing 110. In some embodiments, the sealing part 140 circumferentially extends, and the sealing part 140 is ring-shaped. In some embodiments, the sealing part 140 may be, for example, a sealing strip, a sealing washer or other suitable material. Since the sealing part 140 is clamped between the bottom surface 1241b of the lower cover main body 1241 and the front end surface 110a of the opening OP of the housing 110, seams located between the lower over main body 1241 and the edge of the opening OP of the housing 110 can be well sealed, thereby preventing the external moisture from entering the socket 130 located inside the accommodating space AS of the housing 110.

Reference is made again to FIG. 7. As shown in FIG. 7, as the lower cover 124 is coupled to the upper cover 122, the lower cover main body 1241 contacts the upper cover main body 1221. As the connecting portion 1242 passes through the aperture AP of the upper cover 122, the elastic arms 1222 are located between the guiding inclined surface 1242b and the top surface 1242a of the lower cover main body 1241, and the finger portion 1225 of each of the elastic arms 1222 contacts the side surface 1242c of the connecting portion 1242. Specifically, the guiding inclined surface 1242b has an uppermost portion directly connected to the top surface 1242a and a lowermost portion close to the side surface 1242c. The connecting portion 1242 has a first width W1 at the uppermost portion of the guiding inclined surface 1242b. The connecting portion 1242 has a second width W2 at the lowermost portion of the guiding inclined surface 1242b. In some embodiments, the second width W2 is greater than the first width W1. In some embodiments, the second width W2 is greater than a width along two opposite ends of the side surface 1242c, such that the upper cover 122 is more difficult to be disengaged from the lower cover 124. In some embodiments, the top surface 1242a of the connecting portion 1242 is higher than a top surface of the upper cover main body 1221 as the connecting portion 1242 passes through the aperture AP of the upper cover 122.

In some embodiments, a thickness of each of the elastic arms 1222 in z-direction is substantially equal to a distance between the lowermost portion of guiding inclined surface 1242b and the top surface 1242a of the lower cover main body 1241.

Reference is made again to FIG. 7. As shown in FIG. 7, the connector assembly 100 further includes at least one conductive terminal TMN. The at least one conductive terminal TMN is located with the socket 130. The at least one conductive terminal TMN is configured to be coupled to a pin of the plug (not depicted).

In a usage scenario, when the lower cover 124 is connected to the upper cover 122, the connecting portion 1242 penetrates among the elastic arms 1222, the guiding inclined surface 1242b contacts the elastic arms 1222 The connecting portion 1242 and the elastic arms 1222 move relatively to each other, and the guiding inclined surface 1242b can push the elastic arms 1222 to deform toward the second slot 1224 along the radial direction until the portion of the connecting portion 1242 defined by the guiding inclined surface 1242b and the top surface 1242a is exposed from the elastic arms 1222. Thus, the elastic arms 1222 lose a thrust from the guiding inclined surface 1242b and elastically recover to the original position, and the elastic arms 1222 abut against the side surface 1242c of the connecting portion 1242, thereby realizing the quick disconnection and connection between the upper cover 122 and the lower cover 124.

From the above detailed description of the specific embodiments of the present disclosure, it can be clearly seen that in the water proof cover and the connector assembly of the present disclosure, the water proof cover aims to realize a soft connection between the upper cover and the lower cover, eliminate assembly stress, and prevent the upper cover from deteriorating.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A waterproof cover, comprising:
an upper cover comprising an upper cover main body and a plurality of elastic arms extending from the upper cover main body, wherein the elastic arms surround and jointly define an aperture, and wherein the upper cover has a first slot and a second slot between the upper cover main body and each of the elastic arms, such that the elastic arms deform in a radial direction; and
a lower cover coupled to the upper cover, the lower cover comprising a lower cover main body and a connecting portion interconnected with each other, wherein the connecting portion passes through the aperture and is clamped by the elastic arms.

2. The waterproof cover of claim 1, wherein the elastic arms comprise at least two elastic arms disposed spaced apart from each other along a circumferential direction, and wherein the at least two elastic arms jointly abut against a side surface of the connecting portion.

3. The waterproof cover of claim 1, wherein the elastic arms comprise three elastic arms disposed spaced apart from each other along a circumferential direction, wherein lengths of the three elastic arms are identical, and wherein the three elastic arms jointly abut against a side surface of the connecting portion.

4. The waterproof cover of claim 1, wherein each of the elastic arms has a fixed end contacting the upper cover main body and a free end separated from the upper cover main body by the first slot and a second slot, and wherein the upper cover further comprises a finger portion disposed on a side of each of the elastic arms away from the upper cover main body and abutting against the connecting portion.

5. The waterproof cover of claim 4, wherein the finger portion is located at the free end of each of the elastic arms.

6. The waterproof cover of claim 1, wherein the connecting portion further has a side surface, a top surface over the side surface, and a guiding inclined surface connected to the top surface and between the side surface and the top surface, and wherein the elastic arms are located between the guiding inclined surface and a top surface of the lower cover main body.

7. The waterproof cover of claim 6, wherein the guiding inclined surface extends along a circumferential direction of the connecting portion.

8. The waterproof cover of claim 6, wherein the guiding inclined surface is inclined away from a central axis of the connecting portion along a direction from the top surface of the connecting portion to the top surface of the lower cover main body.

9. The waterproof cover of claim 6, wherein the top surface of the connecting portion is higher than a top surface of the upper cover main body.

10. The waterproof cover of claim 6, wherein the connecting portion has a first width at an uppermost portion of the guiding inclined surface and a second width of at a lowermost portion of the guiding inclined surface, and the second width is greater than the first width.

11. The waterproof cover of claim 1, wherein the first slot communicates with the second slot, and the first slot and the second slot extend in different directions.

12. The waterproof cover of claim 1, wherein the first slot is radially extended and the second slot is circumferentially extended.

13. The waterproof cover of claim 1, wherein the elastic arms circumferentially extend from the upper cover main body.

14. The waterproof cover of claim 1, wherein the aperture is located at a center of the upper cover main body.

15. A connector assembly, comprising:
a housing having an accommodating space and an opening at an end of the housing;
a waterproof cover sealing the opening of the housing, comprising:
an upper cover comprising an upper cover main body and a plurality of elastic arms extending from the upper cover main body, wherein the elastic arms surround and jointly define an aperture, and wherein the upper cover has a first slot and a second slot between the upper cover main body and each of the elastic arms, such that the elastic arms deform in a radial direction; and
a lower cover coupled to the upper cover, the lower cover comprising a lower cover main body and a connecting portion interconnected with each other, wherein the connecting portion passes through the aperture and is clamped by the elastic arms; and
a socket located in the accommodating space.

16. The connector assembly of claim 15, wherein the lower cover main body covers an edge of the opening.

17. The connector assembly of claim 15, wherein the housing further has a front end surface extending along an edge of the opening.

18. The connector assembly of claim 17, further comprising a sealing part located between a bottom surface of the lower cover main body and the front end surface of the opening of the housing.

19. The connector assembly of claim 15, wherein the elastic arms circumferentially extend from the upper cover main body.

20. The connector assembly of claim 15, wherein the waterproof cover is pivotally connected to the housing.
